(19) United States
(12) Patent Application Publication
(10) Pub. No.: US 2021/0285323 A1
(43) Pub. Date: Sep. 16, 2021

(54) HYDRAULIC FRACTURE PROXIMITY DETECTION USING STRAIN MEASUREMENTS

(71) Applicant: HALLIBURTON ENERGY SERVICES, INC., Houston, TX (US)

(72) Inventors: Eric James DAVIS, El Cerrito, CA (US); Emily Xu FRAME, Katy, TX (US); Baidurja RAY, Houston, TX (US)

(21) Appl. No.: 16/818,858

(22) Filed: Mar. 13, 2020

(51) Int. Cl. E21B 49/00; E21B 43/26; E21B 47/12; G01V 99/00; G01V 1/52; G01L 5/00

(52) U.S. Cl. CPC E21B 49/00; E21B 43/26; E21B 47/12; E21B 47/06; G01V 1/52; G01L 5/00; G01V 99/005

(57) ABSTRACT

Described are systems and methods for determining a distance between a hydraulic fracture of a child well to a parent wellbore of a parent well. A distributed accoustic sensor fiber optic cable measures strain measurements along a length of the parent wellbore. A computing device then calculates the distance between the hydraulic fracture and the parent wellbore by inputting the strain measurements into a fracture strain model to solve for a location of the hydraulic fracture. A sub-surface process may be adjusted based on the calculated distance between the hydraulic fracture and the parent wellbore to avoid or utilize a frac hit.

### TECHNICAL FIELD

The present disclosure relates generally to hydraulic fracturing in a well and, more particularly (although not necessarily exclusively), to using strain measurements to detect a hydraulic fracture of a child well approaching a parent well.

### BACKGROUND

Stimulation of a well, including but not limited to fracturing, can be used to extract hydrocarbons from a subterranean formation (e.g., an oil well or a gas well). For example, hydraulic fracturing can include pumping a treatment fluid that includes a proppant mixture into a wellbore to create fractures in the subterranean formation that can allow the hydrocarbons to flow from the subterranean formation and into the wellbore. During the hydraulic fracturing process of the wellbore, a strain field can surround and radiate outward from a fracture as the fracture is formed and causes deformation in the subterranean formation.

Wells drilled in close proximity to one another increase the chances of an interwell communication event, which hereinafter is referred to as a “frac hit,” in which a pressure within a first well (e.g., a “parent well”) is affected by the hydraulic fracturing in a second well (e.g., a “child well” or an “infill well”) due to an interaction between the parent well and the child well, such as when the fracturing treatment of the child well causes a fracture to grow towards and intersect the parent well. Frac hits can result in a loss of production of both the parent well and the child well and in mechanical, physical, or chemical damage to the parent well. Measuring the strain caused by the fractures can provide beneficial data that can be used during the treatment of a wellbore.

### BRIEF DESCRIPTION OF THE DRAWINGS

FIG. 1 is a schematic diagram of an example of a well system for using strain measurements to determine a distance between a fracture of a child well and a wellbore of a parent well according to some aspects of the present disclosure.

FIG. 2 is a block diagram of an example of a computing system that can be used as part of a well system for using strain measurements to determine a distance between a fracture of a child well and a wellbore of a parent well according to some aspects of the present disclosure.

FIG. 3 is a graphical image of an exemplary calculation of a distance between a fracture of a child well and a wellbore of a parent well according to some aspects of the present disclosure.

FIG. 4 is a graph of a correlation between the distance between a fracture of a child well and a wellbore of a parent well and the zero-to-zero distance of a theoretical strain pattern.

FIG. 5 is a flowchart of an exemplary process for using strain measurements to determine a distance between a fracture of a child well and a wellbore of a parent well according to some aspects of the present disclosure.

### DETAILED DESCRIPTION

Certain aspects and examples of the present disclosure relate to methods and systems for using strain measurements to determine a distance between a fracture of a child well and a wellbore of a parent well, or an offset well in some aspects where a parent-child relationship does not exist. In some aspects, the parent well may include a strain measurement device, such as a distributed acoustic sensing (DAS) fiber optic cable, deployed in or close to the parent wellbore and a computing device. The DAS cable may measure strain in the subterranean formation as the formation deforms. For example, as the child well undergoes a hydraulic fracturing treatment to create fractures in the child well, the DAS cable can measure the strain in the formation surrounding the parent wellbore induced by the creation of the fractures. These strain measurements gathered by the DAS cable may be used to determine a distance between a fracture (for example a tip or edge of the fracture) of the child well and the wellbore of the parent well.

These strain measurements are sent to the computing device via wired or wireless communication. The computing device may calculate an approximate distance between the fracture in the formation and the wellbore of the parent well by using a fracture strain model. In some aspects, the fracture proximity is the distance between the fracture in the formation and the wellbore of the parent well. The fracture strain model is an equation that uses the strain measurements to extract at least one parameter of the fracture, or fracture property, to determine the approximate distance between the fracture and the parent wellbore.

Determining the distance between the fracture and the parent wellbore using the strain measurements enables real-time detection of the relative location of the fracture as the fracture approaches the parent wellbore. This detection may enable real-time control actions for the hydraulic fracturing treatment of the child well. For example, where the distance between the fracture and the parent wellbore is determined to be decreasing such that it indicates that the fracture is growing towards the parent wellbore and a frac hit with the parent wellbore may occur, then the hydraulic fracturing treatment of the child well can be adjusted in real-time to avoid the frac hit between the fracture and the parent wellbore.

Additional data gathered from or known about the parent well, the child well, or the hydraulic fracturing treatment may also be used to help determine the approximate distance between the fracture and the parent wellbore. Utilizing the strain measurements and additional data may result in a more accurate determination of the distance between the fracture and the parent well and may enable the determination of additional parameters or characteristics of the fracture.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

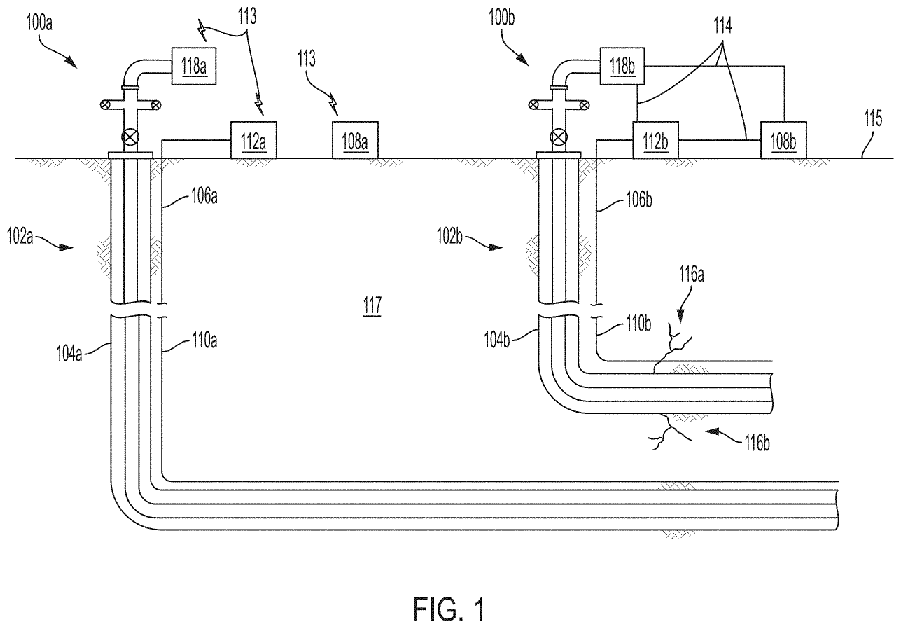

FIG. 1 is a schematic diagram of a parent well 100a and a child well 100b according to some aspects of the present disclosure. The parent well 100a and the child well 100b may include the same features as one another or may include different features depending on certain aspects of the parent well 100a and the child well 100b.

The parent well 100a and the child well 100b each include a respective wellbore 102a, 102b extending from a surface 115 and drilled through a subterranean formation 117 for extracting hydrocarbons (e.g., natural gas or oil) from the subterranean formation 117. In some aspects, each wellbore 102a, 102b may include a vertical wellbore and/or a lateral wellbore that extends substantially horizontally from the vertical wellbore (as is shown in FIG. 1). A hydraulic fracturing system 118a, 118b may be positioned at the surface 115 of the parent well 100a and the child well 100b, respectively, and may be used to hydraulically fracture the respective parent well 100a and child well 100b.

A casing 104a, 104b may be positioned in each wellbore 102a, 102b during the completion of the respective parent well 100a and child well 100b. The casing 104a, 104b may extend for a length of each wellbore 102a, 102b and may help support the stability of the respective wellbore 102a, 102b. In some aspects, cement may be injected into each wellbore 102a, 102b and allowed to set between an outer surface of the respective casing 104a, 104b and an inner surface of the respective wellbore 102a, 102b.

In some aspects, the parent well 100a has not undergone a hydraulic fracturing treatment while the child well 100b undergoes the hydraulic fracturing treatment. In further aspects, the parent well 100a has already undergone the hydraulic fracturing treatment while the child well 100b undergoes the hydraulic fracturing treatment. Fractures 116a, 116b are formed in the formation 117 as the child well 100b undergoes the hydraulic fracturing treatment using a hydraulic fracturing system, for example the hydraulic fracturing system 118b.

In some aspects, the parent well 100a and the child well 100b may include at least one strain measurement device 106a, 106b and at least one computing device 108a, 108b positioned at a surface 115 of each wellbore 102a, 102b. In further aspects, only the parent well 100a may include at least one strain measurement device 106a, or only the child well 100b may include at least one strain measurement device 106b. The strain measurement device 106a, 106b may be a fiber optic cable 110a, 110b that extends from the surface 115 downhole along a length of the respective wellbore 102a, 102b. The strain measurement device 106a, 106b may be deployed in the formation 117 proximate to the respective wellbore 102a, 102b, in the cement injected into the respective wellbore 102a, 102b, or in the respective casing 104a, 104b. In some aspects, the strain measurement device 106a, 106b may be a vector sensor, a tiltmeter, a resistive strain gauge acting on a plurality of faces of a polyhedron, a three-dimensional piezoresistive sensor, a graphene transistor strain sensor, a Fiber Bragg grating strain sensor, a gravitational direction sensing element, or any other suitable strain sensor.

A mathematical model for the fractures 116a, 116b may include multiple parameters (e.g., fracture properties, parameter constraints, etc.) which may be determined or estimated using fracture modeling. These multiple parameters may include the X, Y, and Z coordinates representing the location of the fracture, the length dimension, width dimension, and height dimension of the fracture, orientation parameters representing the direction from North, the angle from vertical of the fracture plane, and the angle from horizontal of the azimuth, and slip parameters in the orientation directions. Different mathematical models may include the same or different parameters as those listed and may include more or fewer parameters than those listed. Solving for one or more of these parameters can help to create an estimation of an image of the fracture that can then be used during the hydraulic fracturing treatment to adjust the treatment or can then be used to adjust future hydraulic fracturing treatments.

The fiber optic cable 110a, 110b may be communicatively coupled to a sensing system, for example a Distributed Acoustic Sensing (“DAS”) system 112a, 112b positioned at the surface 115. Each DAS system 112a, 112b may also be communicatively coupled to the respective computing device 108a, 108b and/or the respective hydraulic fracturing system 118a, 118b. The DAS system 112a, 112b, the computing device 108a, 108b, and the hydraulic fracturing system 118a, 118b may be communicatively coupled using a wireless communication link 113 (as shown in the child well 100b) or a wired communication link 114 (as shown in the parent well 100a). However, any combination of wireless communication links and wired communication links may be used to communicatively couple the respective DAS system 112a, 112b, the respective computing device 108a, 108b, and/or the respective hydraulic fracturing system 118a, 118b. Additionally, the computing device 108a, the DAS system 112a, and/or the hydraulic fracturing system 118a of the parent well 100a may be communicatively coupled with one or more of the computing device 108b, the DAS system 112b, or the hydraulic fracturing system 118b of the child well 100b.

In some aspects, the computing device 108a, the DAS system 112a, and/or the hydraulic fracturing system 118a may be combined into a single computing device for parent well 100a so that most or all of the data collection, data analysis, and treatment controls are housed in the single computing device for the parent well 100a. Similarly, the computing device 108b, the DAS system 112b, and/or the hydraulic fracturing system 118b may be incorporated into a single computing device for the child well 100b.

Each computing device 108a, 108b may receive information and data from the respective DAS system 112a, 112b related to the data collected by the respective fiber optic cable 110a, 110b. For example, each DAS system 112a, 112b may detect acoustic events near the respective fiber optic cable 110a, 110b, e.g., vibration or deformation of the formation 117 caused by the creation of fractures 116a, 116b during the hydraulic fracturing of the child well 100b, that contribute to strain or displacement of each fiber optic cable 110a, 110b. So each DAS system 112a, 112b may measure changes in strain in the respective fiber optic cable 110a, 110b at a number of locations along a length of each fiber optic cable 110a, 110b.

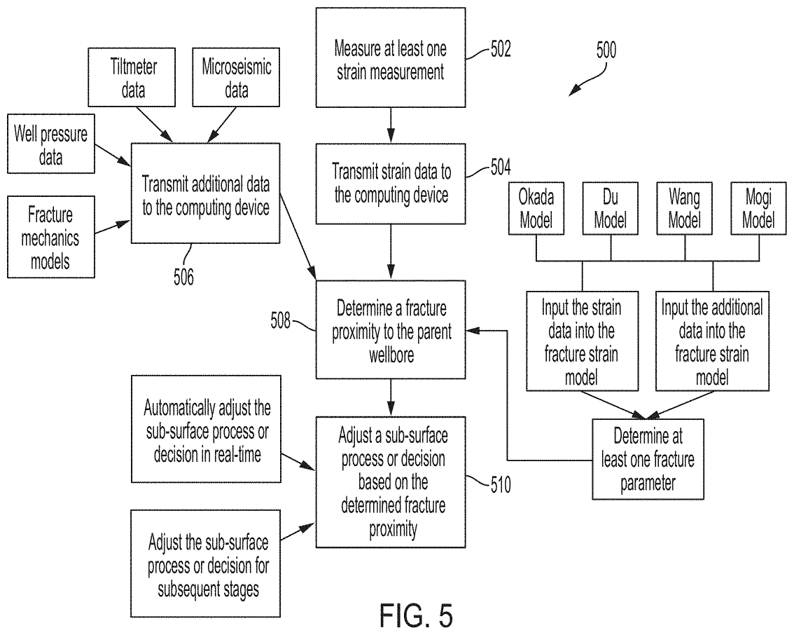

In some aspects, the DAS system 112a may measure the changes in the strain in the fiber optic cable 110a deployed in the parent well 100a along the length the of the fiber optic cable 110 as the child well 100b undergoes the hydraulic fracturing treatment to create fractures 116a, 116b. These changes in strain may be induced by the hydraulic fracturing treatment of the child well 100b resulting in fractures in the formation 117. The DAS system 112a may receive high frequency strain measurements from the fiber optic cable 110a and may filter the high frequency strain measurements to isolate the low frequency strain measurements. The DAS system 112a may then transmit the low frequency strain measurements to the computing device 108a, which may then analyze these low frequency strain measurements, as discussed in further detail below with respect to FIG. 5.

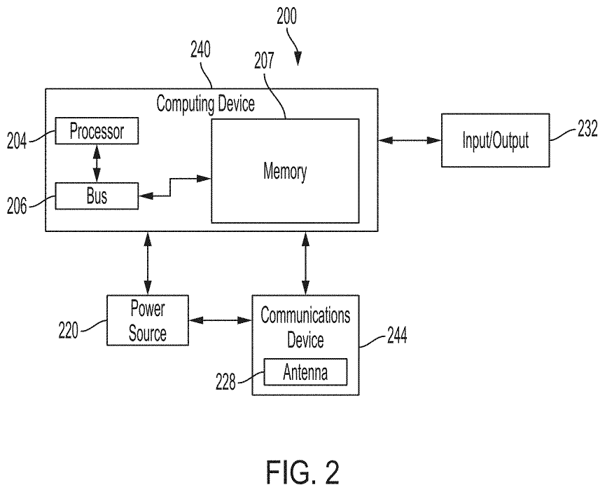

FIG. 2 is a block diagram of a system 200 that can be used to determine a distance between a fracture in a child well (for example child well 100b) and a wellbore of a parent well (for example parent wellbore 102a of parent well 100a) based on strain measurements according to some aspects of the present disclosure. In some examples, the components shown in FIG. 2 (e.g., the computing device 240, power source 220, and communications device 244) can be integrated into a single structure. For example, the components can be within a single housing. In other examples, the components shown in FIG. 2 can be distributed (e.g., in separate housings) and in electrical communication with each other. Additionally, the computing device 240 may be the same as, similar to, or part of the computing device 108a, 108b, the DAS system 112a, 112b, and/or the hydraulic fracturing system 118a, 118b discussed above with respect to FIG. 1.

The system 200 includes a computing device 240. The computing device 240 can include a processor 204, a memory 207, and a bus 206. In some aspects, the processor 204 can execute one or more operations of computer program code instructions to determine a distance between a fracture (e.g., fractures 116a, 116b of a child well (e.g., child well 100b) and a parent wellbore of a parent well (e.g., parent wellbore 102a and parent well 100a) using strain measurements, e.g., by receiving and analyzing strain data from strain measurement devices in a well (e.g., the parent well 100a and/or the child well 100b discussed above with respect to FIG. 1). The processor 204 can execute instructions stored in the memory 207 to perform the operations. The processor 204 can include one processing device or multiple processing devices. Non-limiting examples of the processor 204 include a Field-Programmable Gate Array (“FPGA”), an application-specific integrated circuit (“ASIC”), a microprocessor, etc.

The processor 204 can be communicatively coupled to the memory 207 via the internal bus 206. The memory 207 may include any type of memory device that retains stored information when powered off. Non-limiting examples of the memory 207 include electrically erasable and programmable read-only memory (“EEPROM”), flash memory, or any other type of non-volatile memory. In some examples, at least part of the memory 207 can include a medium from which the processor 204 can read instructions. A computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C #, etc.

The system 200 can include a power source 220. The power source 220 can be in electrical communication with the computing device 240 and a communications device 244. In some examples, the power source 220 can include a battery or an electrical cable to a power source. In some examples, the power source 220 can include an AC signal generator. The computing device 240 can operate the power source 220 to apply a transmission signal to the antenna 228. For example, the computing device 240 can cause the power source 220 to apply a voltage with a frequency within a specific frequency range to the antenna 228. This can cause the antenna 228 to generate a wireless transmission. In other examples, the computing device 240, rather than the power source 220, can apply the transmission signal to the antenna 228 for generating the wireless transmission.

The system 200 can also include the communications device 244. The communications device 244 can include or can be coupled to the antenna 228. In some examples, part of the communications device 244 can be implemented in software. For example, the communications device 244 can include instructions stored in memory 207. The communications device 244 can receive signals from remote devices and transmit data to remote devices (e.g., a hydraulic fracturing control system if separate from system 200). For example, the communications device 244 can transmit wireless or wired communications that are modulated by data via the antenna 228. In some examples, the communications device 244 can receive signals (e.g., associated with data to be transmitted) from the processor 204 and amplify, filter, modulate, frequency shift, and otherwise manipulate the signals. In some examples, the communications device 244 can transmit the manipulated signals to the antenna 228. The antenna 228 can receive the manipulated signals and responsively generate wireless communications that carry the data.

The system 200 can receive input from sensor(s) (e.g., the strain measurement device 106a, 106b discussed above with respect to FIG. 1) or historical data sources. System 200 in this example also includes input/output interface 232. Input/output interface 232 can connect to a keyboard, pointing device, display device, and other computer input/output devices. An operator may provide input using the input/output interface 232. An operator may also view an advisory display of set points or other information such as a dashboard on a display screen included in input/output interface 232.

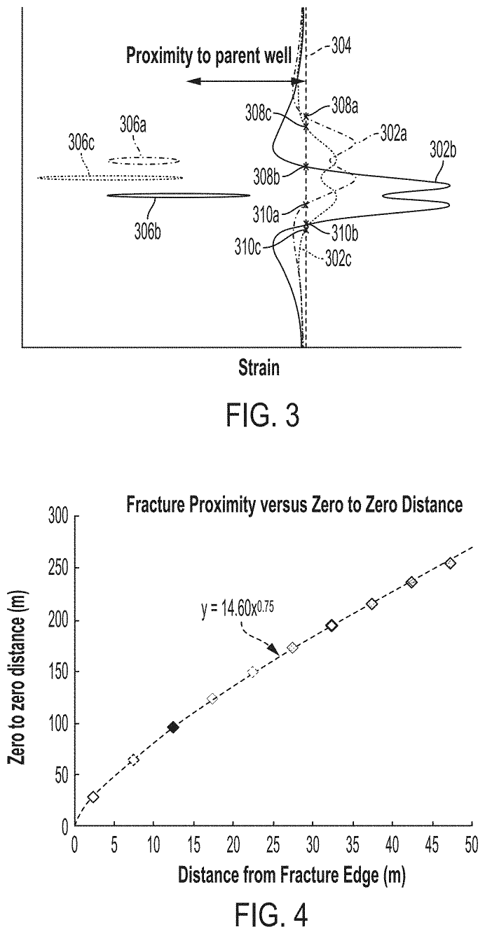

FIG. 3 is a graphical image of a theoretical calculation of a distance between a fracture (e.g., fractures 116a, 116b) in a child well (e.g., child well 100b) to a wellbore of a parent well (e.g., parent wellbore 102a and parent well 100a) according to some aspects of the present disclosure. In some aspects, the parent well is the parent well 100a and the child well is the child well 100b discussed above with respect to FIG. 1.

The graphical image of FIG. 3 shows three theoretical strain patterns 302a, 302b, 302c at a strain measurement device (e.g. fiber optic cable 110a) of a parent well 304 (e.g., parent well 100a) positioned perpendicular to three approaching fractures 306a, 306b, 306c (e.g., fractures 116a, 116b) of a child well (e.g., child well 100b). The strain patterns are created by a mathematical model that uses the fracture parameters and fiber location as inputs. These three theoretical strain patterns 302a, 302b, 302c all exhibit two zero crossings between positive and negative strain. For example, the theoretical strain pattern 302a has the zero crossings 308a, 310a, the theoretical strain pattern 302b has the zero crossings 308b, 310b, and the theoretical strain pattern 302c has the zero crossings 308c, 310c.

In some aspects of this exemplary scenario where the approaching fractures 306a, 306b, 306c are perpendicular to the parent well 304, the distance between the zero crossings of the theoretical strain patterns 302a, 302b, 302c is substantially linearly proportional to the distance of the approaching fractures 306a, 306b, 306c to the parent well 304. For example, the distance between the zero crossings 308a, 310a is substantially proportional to the distance between the approaching fracture 306a and the parent well 304, the distance between the zero crossings 308b, 310b is substantially proportional to the distance between the approaching fracture 306b and the parent well 304, and the distance between the zero crossings 308c, 310c is substantially proportional to the distance between the approaching fracture 306c and the parent well 304.

FIG. 4 depicts a correlation between the distance between a fracture (e.g., fractures 116a, 116b) in a child well (e.g., child well 100b) to a wellbore of a parent well (e.g., parent wellbore 102a and parent well 100a) and the zero-to-zero distance (e.g., the distance between the zero crossings of the theoretical strain pattern 302a, 302b, 302c) of the exemplary strain patterns discussed above with respect to FIG. 3. The equation, y=14.6×^{0.75}, may be used to represent this correlation with y being the zero-to-zero distance and x being the distance between the fracture and the parent wellbore. This correlation assumes that the approaching fracture 306a, 306b, 306c make a perpendicular approach to the parent well 304, that the parent well 304 is linear, and that there are no other nearby approaching fractures.

FIG. 5 is a flowchart of an exemplary process 500 for using strain measurements to determine a distance between a fracture (e.g., fractures 116a, 116b) in a child well (e.g., child well 100b) to a wellbore of a parent well (e.g., parent wellbore 102a and parent well 100a) according to some aspects of the present disclosure. While the process 500 shows various steps arranged in a given order, any number of the steps may be omitted or performed in an alternate order.

At step 502, the process 500 may include measuring at least one strain measurement using a strain measurement device (e.g., strain measurement device 106a) In some aspects, the strain measurement device may be a fiber optic cable, a vector sensor, a tiltmeter, a resistive strain gauge acting on a plurality of faces of a polyhedron, a three-dimensional piezoresistive sensor, a graphene transistor strain sensor, a Fiber Bragg grating strain sensor, a gravitational direction sensing element, or any other suitable strain sensor. Additional strain measurement devices may be associated with at least one of the parent well, with the child well, or with one or more offset wells and may be used to gather strain measurements. The at least one strain measurement may be sensitive to a distance between an approaching fracture and the wellbore of the parent well and may contain more information than simply whether a frac hit between a parent well and a fracture of a child well has occurred.

At step 504, the process 500 may include transmitting strain data to a computing device (e.g., at least one of DAS system 112a or computing device 108a). In some aspects, the strain data may include the strain measurements measured at step 502.

In some aspects, at step 506, the process 500 may include transmitting additional data to the computing device. For example, microseismic data, tiltmeter data, well pressure data, etc. may be sent to the computing device from various measurement devices in the parent well, the child well, and/or one or more offset well. The additional data may include fracture mechanics models, for instance that from Perkins, Kern and Nordgren (PKN), Kristianovitch, Geertsma and de Klerk (KDG), numerical models, etc., and/or predictions taken from the fracture mechanics models. The microseismic data may be obtained, for example but without limitation, from fiber optic DAS cables and/or geophones, which may be deployed in the parent well, the child well, one or more offset well, and/or at the earth surface. The tiltmeter data may include strain gradients based on deformation measurements measured by tiltmeters deployed in the parent well, the child well, one or more offset well, and/or at the earth surface. Additionally, data from fracture mechanics models, which can include measured or estimated data such as the rate and type of fluid pumped, DAS-based downhole cluster flow estimates, estimated formation properties, bottom-hole pressures, well-head pressures, pressures in the subterranean formation, etc., or the fracture mechanics models themselves may be transmitted to the computing device.

At step 508, the process 500 may include determining, using a computing device, a distance between an approaching fracture of the child well and the wellbore of the parent well. As was previously mentioned, the fracture proximity is the distance between the approaching fracture of the child well and the wellbore of the parent well. In some aspects, determining the distance between an approaching fracture of the child well and the wellbore of the parent well may include inputting the strain data into a fracture strain model and solving for fracture parameters that correspond to the location, dimensions, orientation, and slip of the fracture(s). Some of these parameters may be difficult or impossible to determine uniquely (e.g., determining individual parameter measurements), but often the non-unique solutions result in similar distances between the fracture(s) and parent well. The additional data may also be input into the fracture strain model for determining the distance between an approaching fracture of the child well and the wellbore of the parent well.

Non-exclusive examples of a fracture strain model that may be used are the Okada model, the Du model, the Wang model, and the Mogi model. References to papers describing these models are included below. However, any other suitable model may be used, such as a predetermined correlation, an analytical model, a numerical model, etc.

Thus, select fracture parameters (e.g. the X, Y, Z coordinates of the fracture) of the fracture strain model may be extracted, solved for, or constrained by data collected by the fiber optic cable, other strain measurement devices, tilt meters, microseismic sensors, pressure sensors, temperature measuring devices, etc. that relates or corresponds to known or estimates of the other fracture parameters (e.g. the orientation, the length, the width, the height, the horizontal/vertical parameter, the strike/slip parameter, etc.). For example, the Okada model includes ten fracture parameters (e.g., the X, Y, and Z coordinates representing the location of the fracture, the length dimension, width dimension, and height dimension of the fracture, two orientation parameters representing what direction from north the fracture is pointing and the angle from horizontal, a horizontal/vertical slip parameter, and a strike/slip parameter). If each of the ten fracture parameters were known, then it would be possible to determine what the strain should be at a point along the parent wellbore by solving for the strain values of the fracture strain model at the point along the parent wellbore. Similarly, where the strain is known at a point along the parent wellbore (e.g. as measured by a strain measurement device, for example strain measurement device 106a in FIG. 1) other fracture parameters of the fracture strain model may be solved for, including but not limited to the X, Y, Z coordinates of the fracture (e.g. the tip or edge of the fracture). Thus, the computing device (e.g. computing device 108a) may solve for one or more fracture parameters (e.g. the X. Y, Z locations of the fracture) using a fracture strain model and the known strain measurements.

In some aspects, all of the strain data and all of the additional data may be combined into a single fracture strain model to determine the distance between the fracture of the child well and the wellbore of the parent well. Or the strain data and the additional data may be analyzed using separate models then the outputs from the separate models may be consolidated to determine the distance between the fracture of the child well and the wellbore of the parent well. Utilizing the additional data as well as the strain data may enable a more accurate determination of the distance between the fracture of the child well and the wellbore of the parent well and, in some aspects, may enable the determination of additional fracture parameters. For example, the strain data and/or the additional data may be input into a fracture strain model to constrain some other parameters of the fracture growth including the number and location of the fractures, the angle of the fracture relative to the child well, and the volume of the fracture.

At step 510, the process 500 may include adjusting a sub-surface process or a sub-surface decision based on the determined distance between the fracture of the child well and the wellbore of the parent well from step 508. Adjusting the sub-surface process or the sub-surface decision may occur in real-time during the ongoing treatment of the child well. For example, the hydraulic fracturing treatment of the child well may be adjusted if the distance between the fracture of the child well and the wellbore of the parent well is observed to be decreasing at a rate that indicates that the approaching fracture will intersect with the wellbore of the parent well, e.g., a frac hit will occur, before the end of the hydraulic fracturing treatment. In some aspects, the pumping rate of a treatment fluid into the child well may be reduced or stopped or a diverter may be deployed in the child well to adjust the fluid flow through existing fractures. Adjusting the sub-surface process or the sub-surface decision may be performed either to avoid a frac hit or to induce a frac hit.

In some aspects where the distance between the fracture of the child well and the wellbore of the parent well indicates that the approaching fracture will not intersect with the wellbore at the current pumping rate of the hydraulic fracturing treatment, the pumping rate of the treatment fluid into the child well may remain the same for an extended time period, may be increased, or a planned diverter may not be applied to the child well. In further aspects, a sub-surface process in the parent well may be adjusted during the ongoing treatment of the child well. For example, a pressure may be increased within the parent wellbore such as by pumping liquids, gases, etc. into the parent wellbore.

Other sub-surface decisions for subsequent hydraulic fracturing stages (e.g., planned intervals along the child wellbore designated for fracture treatment) may also be made using the determined distance between the facture of the child well and the wellbore of the parent well. Such sub-surface decisions may include decisions relating to a hydraulic fracturing treatment volume, a hydraulic fracturing treatment rate, a hydraulic fracturing treatment proppant mass, etc. For example, if a frac hit is undesirable and the distance between the facture of the child well and the wellbore of the parent well is small or decreasing at a rate that indicates that a frac hit will occur, in the current hydraulic fracturing stage with high cluster (e.g., groupings of perforations through the wall of the child wellbore) uniformity, then the treatment volume per cluster may be reduced for the next hydraulic fracturing stage. However, if the cluster uniformity is low in the current hydraulic fracturing stage, then a diverter may be planned to be deployed for the next hydraulic fracturing stage. If a frac hit is desired, then the opposite decisions may be taken.

In some aspects, the computing device (e.g., computing device 108a) that determines the distance between the fracture of the child well and the wellbore of the parent well may be in communication with the computing device (e.g., hydraulic fracturing system 118b) that controls the hydraulic fracturing treatment of the child well. This communication may cause the computing device (hydraulic fracturing system 118b) to trigger control actions so that the ongoing sub-surface process is automatically (e.g., with little or no user involvement) adjusted in real-time (e.g., as the ongoing sub-surface process is being performed) based on the determined distance between the fracture and the parent wellbore to avoid a frac hit with the parent well.

In some aspects, methods and systems for using strain measurements to determine a proximity of a fracture in a child well to a wellbore of a parent well are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a method for detecting a distance between a hydraulic fracture of a child well and a parent wellbore of a parent well comprising: measuring, by a strain measurement device, at least one strain measurement at least one point along a length of the parent wellbore; transmitting strain data comprising the at least one strain measurement to a computing device; determining, by the computing device, a fracture proximity to the parent wellbore by inputting the at least one strain measurement into a fracture strain model and solving for a location of the hydraulic fracture; and adjusting, by the computing device, at least one of a sub-surface process or a sub-surface decision based on the determined fracture proximity during a treatment of the child well.

Example 2 is the method of example(s) 1, wherein the strain measurement device comprises at least one of a distributed acoustic sensor fiber optic cable, a tiltmeter, a resistive strain gauge acting on a plurality of faces of a polyhedron, a piezoresistive sensor, a graphene transistor strain sensor, a Fiber Bragg grating strain sensor, or a gravitational direction sensing element.

Example 3 is the method of example(s) 1, wherein at least one additional strain measurement device is deployable in at least one of a subterranean formation adjacent to the parent wellbore, the parent wellbore, the subterranean formation adjacent to a child wellbore of the child well, the child wellbore, the subterranean formation adjacent to an additional offset wellbore, or the additional offset wellbore.

Example 4 is the method of example(s) 1, wherein the sub-surface process comprises pumping a treatment fluid into the child well during a hydraulic fracturing treatment; and wherein a pumping rate of the treatment fluid is decreased in response to determining that the fracture proximity is decreasing at a rate that indicates a frac hit will occur, and wherein the sub-surface decision comprises at least one decision relating to at least one of a hydraulic fracturing treatment volume, a hydraulic fracturing treatment rate, or a hydraulic fracturing treatment proppant mass.

Example 5 is the method of example(s) 1, wherein the fracture strain model comprises a predetermined correlation, the Okada model, the Du model, the Wang model, the Mogi model, an analytical model, or a numerical model.

Example 6 is the method of example(s) 1, wherein additional data comprising at least one of microseismic data, tiltmeter data, child wellbore data, temperature data, or well pressure data is measured from at least one additional measurement device and is transmitted to the computing device.

Example 7 is the method of example(s) 6, further comprising determining, by the computing device, at least one parameter constraint of the hydraulic fracture by inputting at least one of the additional data or the at least one strain measurement into the fracture strain model and solving for the at least one parameter constraint.

Example 8 is the method of example(s) 7, wherein the at least one parameter constraint comprises at least one of a position, a dimension, an orientation, or a slip parameter.

Example 9 is the method of example(s) 1, wherein determining the fracture proximity uses at least one fracture mechanics model or a predetermined correlation.

Example 10 is a system for detecting a distance between a hydraulic fracture of a child well and a parent wellbore of a parent well comprising: a distributed acoustic sensor fiber optic cable positionable in a subterranean formation for sensing at least one strain measurement along a length of the parent wellbore; and a computing device comprising a processor and a memory device coupled with the processor, the memory device containing a set of instructions that, when executed by the processor, cause the processor to: receive the at least one strain measurement from the distributed acoustic sensor fiber optic cable; calculate a fracture proximity to the parent wellbore by inputting the at least one strain measurement into a fracture strain model and solving for a location of the hydraulic fracture; and adjust at least one of a sub-surface process or a sub-surface decision based on the calculated fracture proximity during a treatment of the child well.

Example 11 is the system of example(s) 10, wherein the sub-surface process comprises pumping a treatment fluid into the child well during a hydraulic fracturing treatment; and wherein a pumping rate of the treatment fluid is decreased in response to determining that the fracture proximity is decreasing at a rate that indicates a frac hit will occur, and wherein the sub-surface decision comprises at least one decision relating to at least one of a hydraulic fracturing treatment volume, a hydraulic fracturing treatment rate, or a hydraulic fracturing proppant mass for at least one subsequent stage of the child well.

Example 12 is the system of example(s) 10, wherein the fracture strain model comprises a predetermined correlation, the Okada model, the Du model, the Wang model, or the Mogi model, an analytical model, or a numerical model.

Example 13 is the system of example(s) 10, wherein the fracture proximity is calculated using at least one fracture mechanics model or a predetermined correlation.

Example 14 is the system of example(s) 10, wherein the set of instructions that, when executed by the processor, further cause the processor to calculate at least one parameter constraint of the hydraulic fracture by inputting at least one of the at least one strain measurement or additional data into the fracture strain model and solving for the at least one parameter constraint.

Example 15 is a method for detecting a distance between a hydraulic fracture of a child well and a parent wellbore of a parent well comprising: measuring a plurality of strain measurements along a length of the parent wellbore using a distributed acoustic sensor fiber optic cable positionable in a subterranean formation; transmitting the plurality of strain measurements to a computing device; calculating, by the computing device, a fracture proximity to the parent wellbore by inputting the plurality of strain measurements into a fracture strain model and solving for a location of the hydraulic fracture; and adjusting, by the computing device, an on-going hydraulic fracturing treatment of the child well during the on-going hydraulic fracturing treatment based on the calculated fracture proximity.

Example 16 is the method of example(s) 15, wherein the fracture strain model comprises a predetermined correlation, the Okada model, the Du model, the Wang model, the Mogi model, an analytical model, or a numerical model.

Example 17 is the method of example(s) 15, wherein adjusting the on-going hydraulic fracturing treatment comprises at least one of changing a pumping rate of a treatment fluid or deploying a diverter into a child wellbore of the child well to limit a flow of the treatment fluid through existing fractures.

Example 18 is the method of example(s) 15, wherein calculating the fracture proximity further comprises analyzing additional data comprising at least one of microseismic data, tiltmeter data, child wellbore data, temperature data, or pressure data.

Example 19 is the method of example(s) 18, further comprising calculating, by the computing device, at least one parameter constraint of the hydraulic fracture by inputting at least one of the additional data or the plurality of strain measurements into the fracture strain model and solving for the at least one parameter constraint.

Example 20 is the method of example(s) 19, wherein the at least one parameter constraint comprises at least one of a position, a dimension, an orientation, or a slip parameter.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

### NON-LIMITING EXEMPLARY FRACTURE STRAIN MODEL REFERENCES

Du, Y., Segall, P. and Gao, H. 1994. Dislocations in inhomogeneous media via a moduli perturbation approach: General formulation and two-dimensional solutions, J. of Geophysical Research, Vol. 99, No. B7, pages 13,767-13779, July 10.
Du, Y., Segall, P. and Gao, H. 1997. Quasi-static dislocations in three dimensional inhomogeneous media, Geophysical Research Letters, Vol. 24, No. 18, pages 2347-2350, September 15.
Okada, Y. 1992. Internal Deformation Due to Shear and Tensile Faults in a Half-Space, Bull. Seism. Soc. Am. 82, 1018-1040.
Wang R, Martin F L, Roth F. Computation of deformation induced by earthquakes in a multi-layered elastic crust—FORTRAN programs EDGRN/EDCMP. Computers & Geosciences. 2003; 29: 195-207.
Wang R, Lorenzo-Martin F, Roth F. PSGRN/PSCMP—a new code for calculating co- and post-seismic deformation, geoid and gravity changes based on the viscoelastic-gravitational dislocation theory. Computers & Geosciences. 2006; 32: 527-541.

What is claimed is:

1. A method for detecting a distance between a hydraulic fracture of a child well and a parent wellbore of a parent well comprising:
measuring, by a strain measurement device, at least one strain measurement at least one point along a length of the parent wellbore;
transmitting strain data comprising the at least one strain measurement to a computing device;
determining, by the computing device, a fracture proximity to the parent wellbore by inputting the at least one strain measurement into a fracture strain model and solving for a location of the hydraulic fracture; and
adjusting, by the computing device, at least one of a sub-surface process or a sub-surface decision based on the determined fracture proximity during a treatment of the child well.

2. The method of claim 1, wherein the strain measurement device comprises at least one of a distributed acoustic sensor fiber optic cable, a tiltmeter, a resistive strain gauge acting on a plurality of faces of a polyhedron, a piezoresistive sensor, a graphene transistor strain sensor, a Fiber Bragg grating strain sensor, or a gravitational direction sensing element.

3. The method of claim 1, wherein at least one additional strain measurement device is deployable in at least one of a subterranean formation adjacent to the parent wellbore, the parent wellbore, the subterranean formation adjacent to a child wellbore of the child well, the child wellbore, the subterranean formation adjacent to an additional offset wellbore, or the additional offset wellbore.

4. The method of claim 1, wherein the sub-surface process comprises pumping a treatment fluid into the child well during a hydraulic fracturing treatment; and wherein a pumping rate of the treatment fluid is decreased in response to determining that the fracture proximity is decreasing at a rate that indicates a frac hit will occur, and wherein the sub-surface decision comprises at least one decision relating to at least one of a hydraulic fracturing treatment volume, a hydraulic fracturing treatment rate, or a hydraulic fracturing treatment proppant mass.

5. The method of claim 1, wherein the fracture strain model comprises a predetermined correlation, the Okada model, the Du model, the Wang model, the Mogi model, an analytical model, or a numerical model.

6. The method of claim 1, wherein additional data comprising at least one of microseismic data, tiltmeter data, child wellbore data, temperature data, or well pressure data is measured from at least one additional measurement device and is transmitted to the computing device.

7. The method of claim 6, further comprising determining, by the computing device, at least one parameter constraint of the hydraulic fracture by inputting at least one of the additional data or the at least one strain measurement into the fracture strain model and solving for the at least one parameter constraint.

8. The method of claim 7, wherein the at least one parameter constraint comprises at least one of a position, a dimension, an orientation, or a slip parameter.

9. The method of claim 1, wherein determining the fracture proximity uses at least one fracture mechanics model or a predetermined correlation.

10. A system for detecting a distance between a hydraulic fracture of a child well and a parent wellbore of a parent well comprising:
a distributed acoustic sensor fiber optic cable positionable in a subterranean formation for sensing at least one strain measurement along a length of the parent wellbore; and
a computing device comprising a processor and a memory device coupled with the processor, the memory device containing a set of instructions that, when executed by the processor, cause the processor to:
receive the at least one strain measurement from the distributed acoustic sensor fiber optic cable;
calculate a fracture proximity to the parent wellbore by inputting the at least one strain measurement into a fracture strain model and solving for a location of the hydraulic fracture; and
adjust at least one of a sub-surface process or a sub-surface decision based on the calculated fracture proximity during a treatment of the child well.

11. The system of claim 10, wherein the sub-surface process comprises pumping a treatment fluid into the child well during a hydraulic fracturing treatment; and wherein a pumping rate of the treatment fluid is decreased in response to determining that the fracture proximity is decreasing at a rate that indicates a frac hit will occur, and wherein the sub-surface decision comprises at least one decision relating to at least one of a hydraulic fracturing treatment volume, a hydraulic fracturing treatment rate, or a hydraulic fracturing proppant mass for at least one subsequent stage of the child well.

12. The system of claim 10, wherein the fracture strain model comprises a predetermined correlation, the Okada model, the Du model, the Wang model, or the Mogi model, an analytical model, or a numerical model.

13. The system of claim 10, wherein the fracture proximity is calculated using at least one fracture mechanics model or a predetermined correlation.

14. The system of claim 10, wherein the set of instructions that, when executed by the processor, further cause the processor to calculate at least one parameter constraint of the hydraulic fracture by inputting at least one of the at least one strain measurement or additional data into the fracture strain model and solving for the at least one parameter constraint.

15. A method for detecting a distance between a hydraulic fracture of a child well and a parent wellbore of a parent well comprising:
measuring a plurality of strain measurements along a length of the parent wellbore using a distributed acoustic sensor fiber optic cable positionable in a subterranean formation;
transmitting the plurality of strain measurements to a computing device;
calculating, by the computing device, a fracture proximity to the parent wellbore by inputting the plurality of strain measurements into a fracture strain model and solving for a location of the hydraulic fracture; and
adjusting, by the computing device, an on-going hydraulic fracturing treatment of the child well during the on-going hydraulic fracturing treatment based on the calculated fracture proximity.

16. The method of claim 15, wherein the fracture strain model comprises a predetermined correlation, the Okada model, the Du model, the Wang model, the Mogi model, an analytical model, or a numerical model.

17. The method of claim 15, wherein adjusting the on-going hydraulic fracturing treatment comprises at least one of changing a pumping rate of a treatment fluid or deploying a diverter into a child wellbore of the child well to limit a flow of the treatment fluid through existing fractures.

18. The method of claim 15, wherein calculating the fracture proximity further comprises analyzing additional data comprising at least one of microseismic data, tiltmeter data, child wellbore data, temperature data, or pressure data.

19. The method of claim 18, further comprising calculating, by the computing device, at least one parameter constraint of the hydraulic fracture by inputting at least one of the additional data or the plurality of strain measurements into the fracture strain model and solving for the at least one parameter constraint.

20. The method of claim 19, wherein the at least one parameter constraint comprises at least one of a position, a dimension, an orientation, or a slip parameter.
